(19) United States
(12) Patent Application Publication
(10) Pub. No.: US 2022/0269820 A1
(43) Pub. Date: Aug. 25, 2022

(54) ARTIFICIAL INTELLIGENCE BASED DATA REDACTION OF DOCUMENTS

(71) Applicant: Accenture Global Solutions Limited, Dublin 4 (IE)

(72) Inventors: Gurpreet Singh Bawa, Gurgaon (IN); Kaustav Pakira, Mumbai (IN); Souvik Chakraborty, Kolkata (IN)

(21) Appl. No.: 17/183,221

(22) Filed: Feb. 23, 2021

(51) Int. Cl. G06F 21/62; G06F 40/186; G06K 9/62; G06N 20/00

(52) U.S. Cl. CPC G06F 21/6254; G06F 40/186; G06K 9/6256; G06N 20/00

(57) ABSTRACT

Aspects of the present disclosure provide systems, methods, and computer-readable storage media supporting automated document redaction in compliance with data privacy requirements. To facilitate data redaction, a document template may be subjected to a template expansion process that generates multiple instances of the template, each instance having data fields populated with arbitrary data (e.g., data that is not subject to the data privacy requirements). The populated templates may then be converted to synthetic data that includes information about the location of the data contents within the populated templates, a copy of the data contents, and structural information. A set of content features and structural features may be generated based on the synthetic data and used to train a model to identify data that should be redacted within a document. Once trained, documents may be evaluated using the model to perform data redaction prior to providing access to the documents.

### TECHNICAL FIELD

The present disclosure relates generally to data privacy systems and more specifically, to systems for utilizing machine learning to automate redaction of information from documents.

### BACKGROUND

A few decades ago users primarily interacted with service providers via in-person communications, such as visiting a doctor's office or purchasing items from a retail store. However, advancements in technology have resulted in many services providers offering access to services being offered to users via online platforms accessible over the Internet, such as online shopping, virtual doctor's visits, and the like. While the ability to access such services via the Internet has made those services more accessible, it has raised new concerns with respect to protecting users' sensitive data, also referred to as personally identifiable information (PII) data. Sensitive or PII data may include a user's name, address(es), e-mail address(es), telephone number(s), financial account or card information, location data, and other types of information that identifies, directly or indirectly, an individual person. Regulation of the use, storage, access, and distribution of sensitive data of users has significantly expanded in recent years in an effort to minimize the harm that may come from the misuse or improper access of sensitive data. As an example, General Data Protection Regulation (GDPR) requirements place significant restrictions on how entities store, share, and use sensitive data.

Efforts to comply with GDPR requirements and other regulations or laws relating to data privacy and security have taken many forms. One exemplary technique that may be used to protect sensitive data is data redaction, which may be performed by covering up certain pieces of information (e.g., with a black box), obfuscating the information (e.g., replacing the sensitive information with nonsensical or predetermined sequences of characters or symbols), or other techniques for concealing the sensitive data. Once the data has been redacted, the document may be shared with a third party without violating applicable data privacy regulations and laws.

While data redaction may minimize the chances that sensitive information is misused or improperly shared, there are several challenges that remain unsolved. For example, current processes to redact sensitive data from documents are performed manually, which can be a time consuming process. Additionally, manual redaction requires that an individual access and view the data to determine which parts of the data should be redacted and which parts of the data should remain (i.e., not be redacted). Performing data redaction in this manner requires the person doing the redaction have authorization to view the data but this can be problematic in some situations, such as when the person responsible for performing the redaction is not, in fact, authorized to access and view the data. Therefore, while data redaction provides one potential way to protect sensitive data shared with third parties, challenges still remain with respect to how the redaction is performed.

### SUMMARY

Aspects of the present disclosure provide systems, methods, apparatus, and computer-readable storage media that support automated document redaction in compliance with data privacy requirements. To facilitate data redaction, a document template may be obtained. A template expansion process may be used to generate multiple instances of the template, and each instance of the template may have data fields populated with arbitrary data (e.g., data that is not subject to the data privacy requirements). In aspects, each instance of the populated template may include different data, thereby providing multiple different copies of the populated template that share the same structural features.

Once the populated templates are generated, a template conversion process may be utilized to convert the populated templates to synthetic data. The synthetic data may have a different format than the populated templates. For example, the templates may correspond to portable data format (.pdf) files or other file types that contain various data fields that may be populated with data values during the template expansion process. The synthetic data may be generated using a structured language format, such as JavaScript Object Notation (JSON), JSON lines (JSONL), or another structured language. Utilizing the structured language format may enable the synthetic data to be more easily ingested by a computer process or software, such as a machine learning process to train a model to identify portions of a document that should be redacted in order to comply with data privacy requirements or for other reasons. The synthetic data may include information about the location of the data contents within the populated templates, a copy of the data contents, and structural information associated with the locations of the data fields and/or data used to populate the templates. In an aspect, synthetic data may also be expanded. For example, an instance of the synthetic data generated from one of the populated templates may be replicated and the data values may be altered to include different data values. The synthetic data expansion process may produce a robust set of information that shares common structural features (e.g., the locations of the data fields, etc.) but different data values, which may enable large sets of training data to be generated quickly for use in training a model.

During training of the model, the synthetic data may be analyzed to determine a set of content features and structural features. The content features may include information associated with characteristics of data within the data fields that may be indicative of sensitive data that should be redacted. For instance, content features may indicate that a term or phrase within the synthetic data that includes a sequence of numbers followed by a sequence of letters may be street address information (e.g., “1234 ZBC Street”). The structural features may include information that indicates a structure of the template, such as locations of the data fields, relationships between data fields, how many pages the template includes, or other types of information. The content features and structural features may be used to train the model to identify data that should be redacted within a document. For example, the model may be trained to identify address information, telephone number information, names, or other types of PII data that is subject to data privacy regulations or requirements. Once training is complete, the model may be used to evaluate documents requested by users and to perform data redaction prior to providing the documents to the user.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an exemplary system that leverages machine learning techniques to redact information from documents according to one or more aspects of the present disclosure;

FIG. 2 is a block diagram illustrating exemplary operations for leveraging machine learning techniques to redact documents according to one or more aspects of the present disclosure;

FIG. 3 is a block diagram illustrating exemplary templates for documents that may be redacted in accordance with aspects of the present disclosure;

FIG. 4 is a block diagram illustrating a template expansion process in accordance with aspects of the present disclosure;

FIG. 5 is a block diagram illustrating a synthetic data generation process in accordance with aspects of the present disclosure;

FIG. 6 is a block diagram illustrating training of a model using synthetic data in accordance with aspects of the present disclosure;

FIG. 7 is an exemplary confusion matrix illustrating performance of a model for data redaction in accordance with aspects of the present disclosure; and

FIG. 8 is a flow diagram illustrating an example of a method for redacting information from documents according to one or more aspects of the present disclosure.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

Aspects of the present disclosure provide systems, methods, apparatus, and computer-readable storage media that support automated redaction of documents. As will be described in more detail below, embodiments may utilize a model to identify portions of a document for redaction. A training process may be utilized to teach the model how to identify content of a document that should be redacted, such as portions of the document that contain sensitive or PII data. To facilitate the training process, templates corresponding to different documents may be obtained. The templates may be blank when obtained and a template expansion process may be used to generate a plurality of populated templates, which are instances of the template that have been populated with arbitrary data (i.e., data that does not include PII data). The populated templates may provide a plurality of non-identical instances of the document that do not contain data subject to data privacy regulations or requirements, thereby enabling the templates to be used to train the model without running the risk of violating the data privacy regulations or requirements.

Once the populated templates are generated, a template conversion process may be utilized to convert the populated templates into a more compact format that is configured for ingestion by the model. For example, the conversion process may analyze the populated templates to identify the data input into the templates during the template expansion process and information about the structure of the populated templates (e.g., polygons bounding different types of information recorded in the populated templates, etc.). The template conversion process may generate synthetic data based on the analysis of the populated templates and the synthetic data may be configured to arrange the populated template data in a more structured or machine readable format. The synthetic data may then be used to train a model to identify information in a document, such as information that should be redacted. Once the model is trained, the model may then be used to analyze documents and perform data redaction.

Utilizing the techniques disclosed herein, redaction of data from documents may be performed in an automated manner, which allows the data redaction to be performed much more quickly than presently available manual techniques. Moreover, the training of the model may be performed without requiring use of documents containing sensitive data, thereby eliminating the risk that sensitive data is used in violation of data privacy regulations. Additionally, the template expansion and conversion processes may create a large data set of documents that are non-identical but share the same structure (i.e., document layout). This increases the accuracy of the model, enabling the automated redaction process to be performed with accuracy levels similar to the presently used manual techniques, but without the risk of the redaction process violating any data privacy regulations or laws.

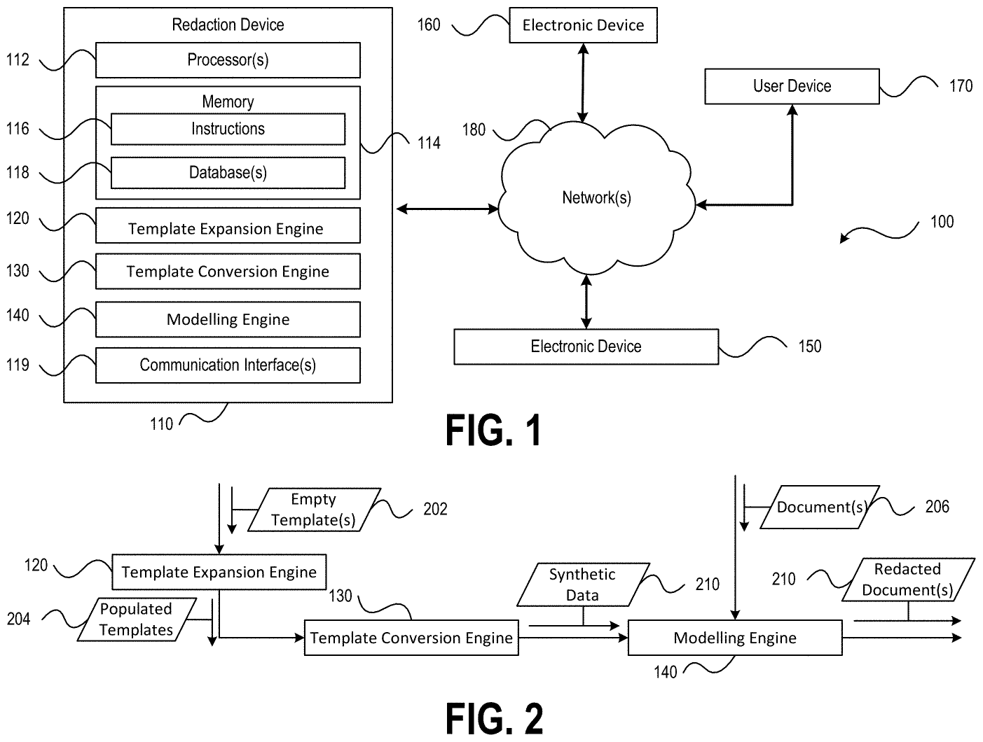

Referring to FIG. 1, a block diagram of an exemplary system that supports leveraging machine learning techniques to redact information from documents according to one or more aspects of the present disclosure is shown as a system 100. As shown in FIG. 1, the system 100 includes a redaction device 110. The redaction device 110 may be communicatively coupled to one or more external devices or systems via one or more networks 180. To illustrate, in the exemplary implementation shown in FIG. 1, the redaction device 110 may be communicatively coupled to an electronic device 150, an electronic device 160, and one or more user devices 170 via the one or more networks 180. The electronic device 150, 160 and/or the user device(s) 170 may provide graphical user interfaces that allow users to interact with and view various types of documents, at least some of which may contain sensitive information. For example, the electronic device 150 may be associated with a financial institution (e.g., bank), the electronic device 160 may be associated with a mortgage broker, and the user device 170 may be associated with an individual seeking to obtain a mortgage loan from the mortgage broker. As part of the mortgage loan process, the individual associated with the user device 170 may provide information to the mortgage broker associated with the electronic device 160. Additionally, the mortgage broker may share or obtain information from the financial institution associated with the electronic device 150. When the data is shared between the mortgage broker and the financial institution, some information may need to be redacted in order to comply with applicable data privacy requirements or regulations. As explained above, it may be improper to allow an individual to manually review and redact information shared between the mortgage broker and the financial institution. To ensure compliance with applicable data privacy requirements, the redaction device 110 may be used to redact information from the document prior to sharing the information between the mortgage broker and the financial institution. Exemplary aspects of performing data redaction via the redaction device 110 are described in more detail below.

The redaction device 110 may include or correspond to a desktop computing device, a laptop computing device, a personal computing device, a tablet computing device, a mobile device (e.g., a smart phone, a tablet, a personal digital assistant (PDA), a wearable device, and the like), a server, a virtual reality (VR) device, an augmented reality (AR) device, an extended reality (XR) device, a vehicle (or a component thereof), an entertainment system, other computing devices, or a combination thereof, as non-limiting examples. The redaction device 110 includes one or more processors 112, a memory 114, one or more communication interfaces 118, one or more input/output (I/O) devices (not shown in FIG. 1), a template expansion engine 120, a template conversion engine 130, and a modelling engine 140. In some other implementations, one or more of the components 112-140 may be optional, one or more additional components may be included in the redaction device 110, or both. It is noted that functionalities described with reference to the redaction device 110 are provided for purposes of illustration, rather than by way of limitation and that the exemplary functionalities described herein may be provided via other types of computing resource deployments. For example, in some implementations, computing resources and functionality described in connection with the redaction device 110 may be provided in a distributed system using multiple servers or other computing devices, or in a cloud-based system using computing resources and functionality provided by a cloud-based environment that is accessible over a network, such as the one of the one or more networks 180. To illustrate, one or more operations described herein with reference to the redaction device 110 may be performed by one or more servers or a cloud-based system that communicates with one or more external devices (e.g., the external devices 150, 160 or the user device(s) 170) via the one or more networks 180.

The redaction device 110 may include one or more processors 112, a memory 114, one or more communication interfaces 119, a template expansion engine 120, a template conversion engine 130, a modelling engine 140. The one or more processors 112 may include one or more microcontrollers, application specific integrated circuits (ASICs), field programmable gate arrays (FPGAs), central processing units (CPUs) having one or more processing cores, or other circuitry and logic configured to facilitate the operations of the redaction device 110 in accordance with aspects of the present disclosure. The memory 114 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the redaction device 110 may be stored in the memory 114 as instructions 116 that, when executed by the one or more processors 112, cause the one or more processors 112 to perform the operations described herein with respect to the redaction device 110. Additionally, the memory 114 may be configured to store data and information, such as one or more databases 118. Illustrative aspects of types of information that may be stored in the one or more databases 118 are described in more detail below.

The one or more communication interfaces 119 may be configured to communicatively couple the redaction device 110 to the one or more networks 180 via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, an IEEE 802.16 protocol, a 3rd Generation (3G) communication standard, a 4th Generation (4G)/long term evolution (LTE) communication standard, a 5th Generation (5G) communication standard, and the like). In some implementations, the redaction device 110 includes one or more input/output (I/O) devices (not shown in FIG. 1) that include one or more display devices, a keyboard, a stylus, one or more touchscreens, a mouse, a trackpad, a microphone, a camera, one or more speakers, haptic feedback devices, or other types of devices that enable a user to receive information from or provide information to the redaction device 110. In some implementations, the redaction device 110 is coupled to the display device, such as a monitor, a display (e.g., a liquid crystal display (LCD) or the like), a touch screen, a projector, a virtual reality (VR) display, an augmented reality (AR) display, an extended reality (XR) display, or the like. In some other implementations, the display device is included in or integrated in the redaction device 110.

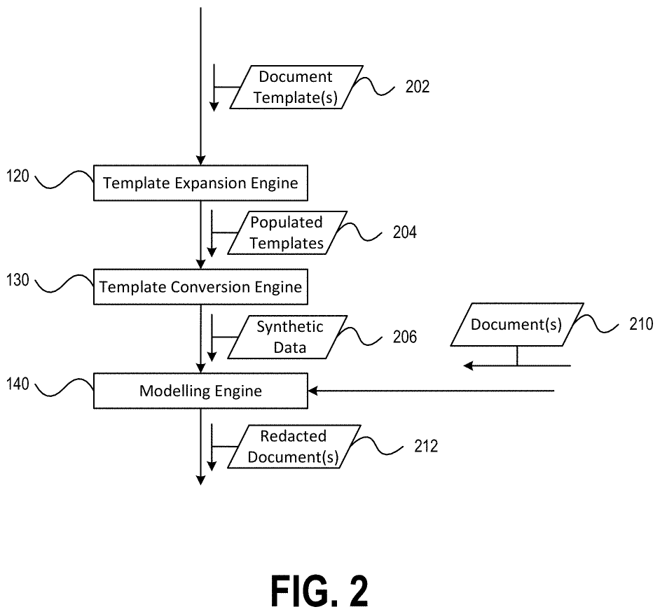

The redaction device 110 may be configured to perform data redaction using a model provided by the modelling engine 140. The model may be trained using information generated by the template expansion engine 120 and the template conversion engine 130. For example and referring to FIG. 2, a block diagram illustrating exemplary operations for leveraging machine learning techniques to redact documents according to one or more aspects of the present disclosure is shown. As shown in FIG. 2, the template expansion engine 120 may receive one or more document templates 202. In the example above involving sharing of data between a mortgage broker and a financial institution, the document template 202 may correspond to the document(s) shared between the mortgage broker and the financial institution. The document template may be blank (i.e., do not contain any information other than the data fields and instructions for populating the data fields of the document) or may include information in at least some of the data fields. If the template is populated with at least some data (i.e., the template is not a blank template), the template expansion engine 120 the data may be removed (e.g., deleted, replaced with blank spaces, etc.) or obfuscated (e.g., replaced with dummy data, etc.) so that the template 202 does not contain any sensitive information prior to utilizing the template for template expansion.

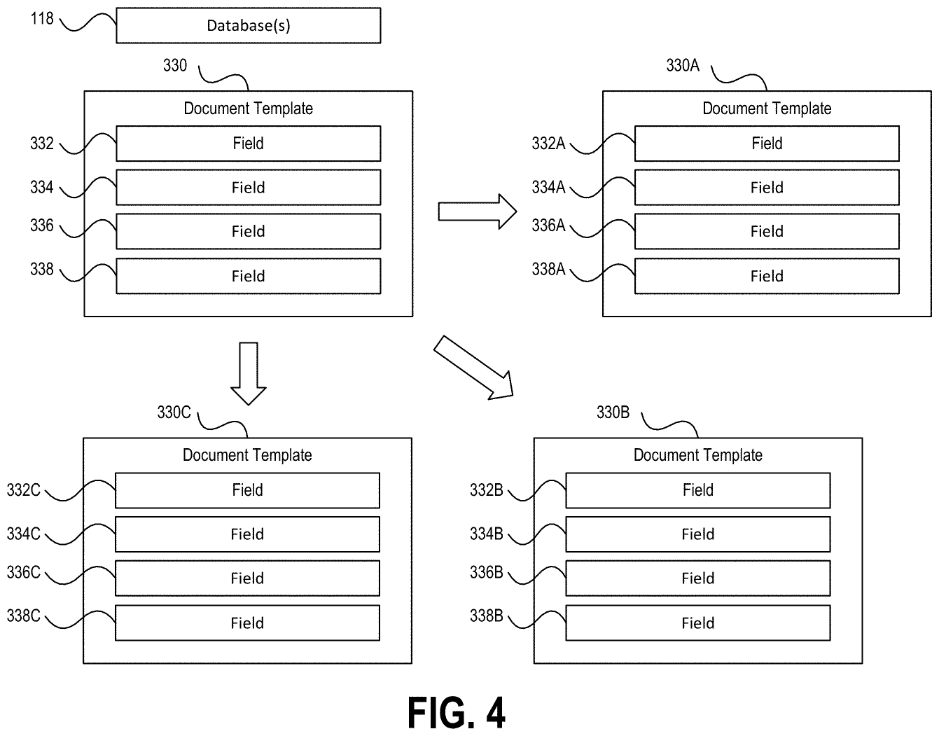

The template expansion engine 120 may be configured to expand the one or more templates 202 to create a plurality of populated templates 204. Expansion of the template(s) 202 may include creating instances of the template 202 and then populating the instances using arbitrary data (i.e., data that does not qualify as sensitive or PII data). Exemplary aspects of populating templates using arbitrary data are described in more detail with reference to FIG. 4. Subsequent to template expansion, the populated templates 204 may be provided to the template conversion engine 130. The template conversion engine 130 may be configured to convert the populated templates 204 to a machine readable format to produce synthetic data 206. The synthetic data 206 may specify characteristics of the templates, such as locations of different data entry fields of the populated templates, and may include the arbitrary data or other content of the populated templates 204. The synthetic data 206 may then be provided to the modelling engine 140, where it may be used to train a model to identify portions of the templates that are associated with sensitive data. Once trained, the model may be used to analyze documents 210 and redact information from the documents to produce redacted documents 212. The redacted documents 212 may then be provided to users or external systems for further processing in a manner that minimizes instances where sensitive data is misused or handled in a way that does not comply with data privacy regulations, such as GDPR requirements or other data privacy requirements. To illustrate, in the example above involving sharing of data between a mortgage broker and a financial institution, the trained model may be used to redact information from the document(s) shared between the mortgage broker and the financial institution. Each of these processes and operations will be described in more detail below.

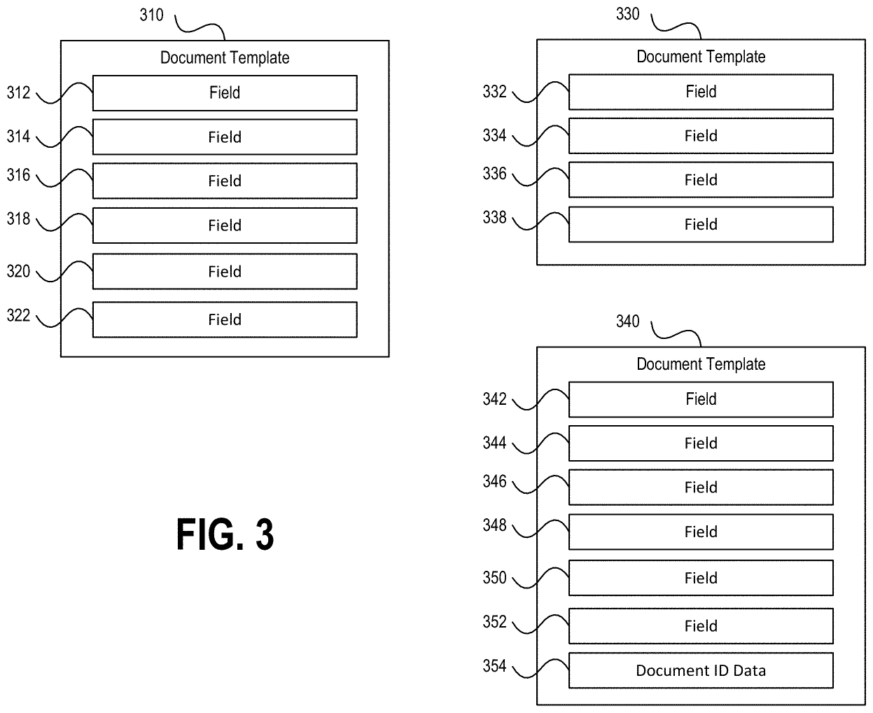

Referring back to FIG. 1, during operation of the system 100, the redaction device 110 may receive one or more templates. For example, the one or more templates may be received from the electronic device 150, the electronic device 160, the user device 170, another device, or a combination of different devices. Non-limiting and illustrative examples of templates that may be received by the redaction device are shown in FIG. 3, which shows a template 310, a template 330, and a template 340. As illustrated in FIG. 3, the template 310 may include a plurality of data fields 312, 314, 316, 318, 320, 322, the template 330 may include a plurality of data fields 332, 334, 336, 338, and the template 340 may include a plurality of data fields 342, 344, 346, 348, 350, 352. Each of the data fields 312, 314, 316, 318, 320, 322, 332, 334, 336, 338, 342, 344, 346, 348, 350, 352 may be configured to receive different types of data, such as text (e.g., name information, notes, etc.), numeric data (e.g., account numbers, telephone numbers, etc.), alphanumeric data (e.g., home addresses, business address, e-mail addresses, etc.), or other types of information. Some of the data fields may be configured to capture data that may be subject to data privacy regulations and laws while other ones of the data fields may be configured to capture data that may not be subject to data privacy regulations or laws.

In some aspects, the template(s) may include information that identifies the document (or form) associated with the template. For example, the template 340 includes document identifier (ID) data 354. The document ID data 354 may include a string of numeric characters (e.g., 1234), alphanumeric characters (e.g., Doc. ID. 123456-1), or other types of information that may be used to identify the document corresponding to the template. It is noted that the exemplary document ID data described above has been provided for purposes of illustration, rather than by way of limitation and that templates and documents analyzed in accordance with aspects of the present disclosure may include document ID data that is different from the examples described herein or may not include document ID data.

Each of the templates 310, 330, 340 may be associated with a different document. For example, the templates 310, 330 may correspond to documents associated with the electronic device 150 and the template 340 may correspond to a document associated with the electronic device 160. In another non-limiting example, the templates 310, 330, 340 may each correspond to documents associated with the electronic device 150. The electronic devices 150, 160 may allow users to populate documents corresponding to the templates 310, 330, 340. Subsequently, the populated documents may be accessed, such as by a user of the user device 170 or shared. To ensure compliance with applicable privacy regulations and laws, access to the populated documents may involve redaction of sensitive data using a redaction device (e.g., the redaction device 110 of FIG. 1) in accordance with the techniques disclosed herein. It is noted that in some aspects a single document may be associated with multiple templates. Additionally, it is noted that some of the data fields of a template may be configured to capture sensitive data (e.g., data subject to data privacy regulations or laws) while other data fields of the template may be configured to capture non-sensitive data. It is to be understood that the templates used by embodiments of the present disclosure are not the same as populated documents. For example, a template may simply be a blank form while a populated document would be an instance of the form that has been completed by an individual and may contain sensitive information subject to data privacy requirements and regulations.

Referring back to FIG. 1, the one or more databases 118 may be configured to store information that may be used to redact documents in accordance with aspects of the present disclosure. For example, the one or more databases 118 may include a templates database configured to store the templates (e.g., the templates 310, 330, 340 of FIG. 3) received by the redaction device 110. The one or more databases 118 may also include a template expansion database configured to store information that may be used to perform expansion of the templates stored in the template database without requiring the use of potentially sensitive data. For example, the template expansion database may store a list of made up names (e.g., names from movies, books, or other names that are not specific to or do not identify an actual person), a list of made up addresses (e.g., fake street addresses, business addresses, cities, states, etc.), or other types of information that may be used to populate the templates without including data that would be subject to data privacy regulations and laws. It is noted that in some aspects, rather than including a template expansion database a user may provide the arbitrary data manually. The one or more databases 118 may also include a synthetic database configured to store synthetic data (e.g., the synthetic data 206 of FIG. 2). Exemplary aspects of generating synthetic data are described in more detail below.

In an aspect, the redaction device may utilize a document cataloguing process to obtain the templates. For example, a data store containing multiple instances of a document of documents may be analyzed to identify different documents. The cataloguing process may determine associations between the different documents, such as to analyze the documents and find different instances of a same document (e.g., an instance of a document populated with information of a first user and an instance of the document populated with information of a second user). Based on the identified document associations, the catalogue of documents may be divided into groups, where each group is associated with a unique document (e.g., all instances of a first documents are arranged within the catalogue as a first document category or class of documents and all instances of a second document are arranged within the catalogue as a first document category or class of documents. Once the different documents are identified, templates corresponding to each category or class of documents may then be selected, generated, (e.g., by removing data values used to populate the data fields of the document) or otherwise obtained.

As briefly described above, the template expansion engine 120 may utilize the information stored in the one or more databases 118 (e.g., a template expansion database) to perform template expansion. To illustrate and referring to FIG. FIG. 4, a block diagram illustrating an exemplary template expansion process in accordance with aspects of the present disclosure is shown. In the exemplary template expansion process shown in FIG. 4, the template 330 of FIG. 3 is expanded using data from the one or more databases 118 to produce a plurality of populated templates (e.g., the populated templates 204 of FIG. 2), which may include populated templates 330A, 330B, 330C. During the template expansion process, information from the template expansion database may be used to populate the data fields 332, 334, 336, 338 of the template 330. For example, the data field 332 may be populated with different types of information to produce data fields 332A, 332B, 332C each of which may include different types of information. The data fields 334, 336, 338 may be similarly populated to produce the data fields 334B, 334C, 336B, 336B, 338B, 338C. It is noted that each of the data fields 332A-338C may be populated with different data. For example, suppose that the data field 332 is configured to capture a name—the data fields 332A, 332B, 332C may each be populated with a different name, which may be selected from arbitrary data (e.g., data that does not identify a specific person) included in the template expansion database or may be created by a user manually. Similarly, address-type data fields may be populated with arbitrary address data (e.g., arbitrary street numbers, street names, cities, states, etc.) from the template expansion database or manually created. To illustrate, suppose that data field 334 is configured to capture a street address and data field 336 may capture a city/state/zip code information. The data fields 334A, 334B, 334C may be populated with arbitrary street addresses and the data fields 336A, 336B, 336C may be populated with arbitrary city/state/zip code data. For example, arbitrary street addresses may include data such as “1234 ABCD Street” and arbitrary city/state/zip code data may include “XYZ Town, AB 12345.” It is noted that the exemplary types of arbitrary data and the types of data fields described above have been provided for purposes of illustration, rather than by way of limitation and that template expansion in accordance with aspects of the present disclosure may utilize other types of data and templates having other types of data fields than those expressly described with reference to FIG. 4. In addition to populating data fields of the template(s) corresponding to sensitive data with arbitrary data, the template expansion process may also populate data fields corresponding to non-sensitive data.

In an aspect, data fields may be identified as corresponding to sensitive data or non-sensitive data based on an analysis of the template(s). For example, information suggestive of a data field configured to capture name information may be present on the template proximate (e.g., to the left of, below, above, etc.) the data field, such as the phrase “first name,” “lase name,” “full name,” or other information being present proximate one or more data fields. As another example, the phrase “street address,” “apartment number,” “city,” “state,” “zip code,” or other types of identifying information may be present proximate data fields configured to capture address information. Similar types of phrases may be present proximate data fields configured to capture account information, telephone number information, e-mail address information, and the like. The template expansion engine may be configured to analyze the template(s) to identify these types of phrases and determine the types of data that should be used to expand the template(s). During the analysis, the template expansion engine may determine an orientation of the phrases relative to the data fields, such as to determine whether the identifying phrases are located to the left of the corresponding data fields, above the corresponding data fields, below the corresponding data fields, and the like. Such analysis may allow the template expansion engine to determine the types of data that should be used to populate the template(s) during the template expansion process. In some aspects, the types of data corresponding to each data field may be manually identified by a user and then automatically populated using the techniques described above (e.g., using a database of arbitrary data) or manually populated.

It is noted that the non-limiting example of FIG. 4 shows the template expansion process as generating three populated templates 330A, 330B, 330C, each of which is an instance of the template 330 of FIG. 3, for purposes of illustration rather than by way of limitation and that template expansion processes according to aspects of the present disclosure may produce more than three populated templates or less than three populated templates. Thus, it is to be understood that template expansion processes according to aspects of the present disclosure may generate a plurality of populated templates, each populated template including arbitrary data that is not subject to data privacy requirements. As described in more detail below, the populated templates produced during template expansion may be used to train a model that, once trained, may be used to automatically redact sensitive information from documents.

Referring back to FIG. 1, as a result of the template expansion process, the redaction device 110 may expand a single (blank) template into multiple populated instances of the template (e.g., the populated templates 204 of FIG. 2 and the populated templates 330A, 330B, 330C of FIG. 4) that are populated with non-sensitive data that may be used for analysis without being subject to data privacy regulations or laws. As briefly described with reference to FIG. 2, the populated templates may be provided to the template conversion engine 130 where they may be transformed into synthetic data (e.g., the synthetic data 206 of FIG. 2). The synthetic data may be generated based on the populated templates and may be presented in a format that may be used by the modelling engine 140 to train a model. Once the model has been trained, the model may then be used to perform automated document redaction, as described in more detail below.

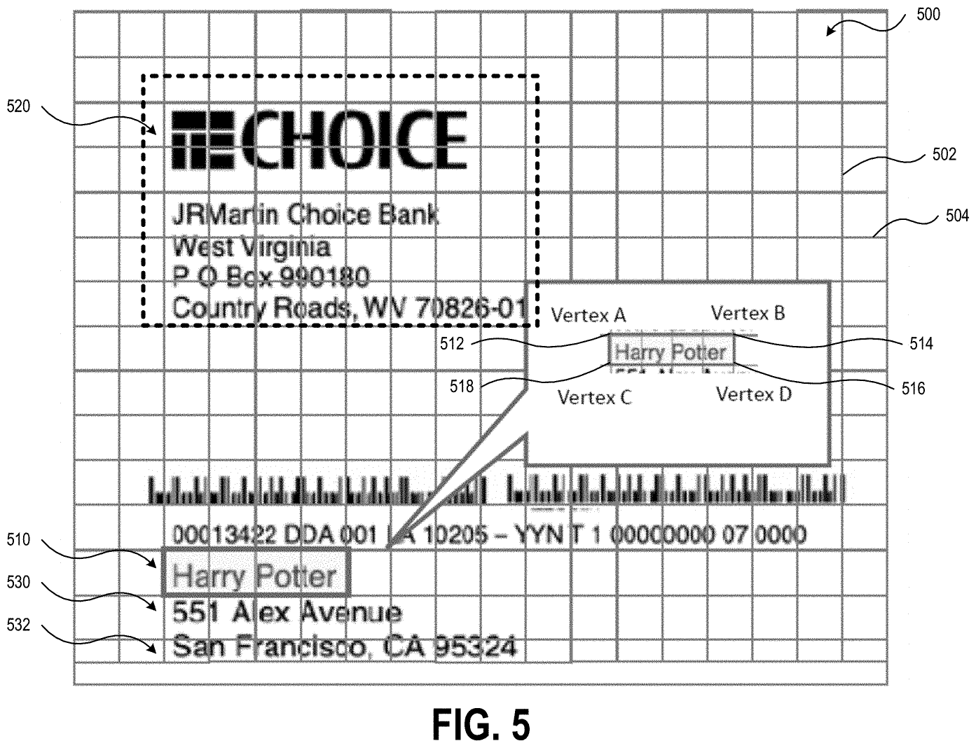

To illustrate and referring to FIG. 5, a block diagram illustrating a synthetic data generation process in accordance with aspects of the present disclosure is shown. In FIG. 5, a populated template 500 is shown. The populated template 500 may be generated using the techniques described above with reference to the template expansion engine 120 of FIG. 1 and FIGS. 3 and 4. As shown in FIG. 5, the populated template 500 includes name data 510, document header data 520, and address data 530, 532. It is noted that the populated template 500 may include additional data not shown in FIG. 5. The name data 510 and the address data 530, 532 may be generated using the expansion process described above with reference to FIG. 4, such as by populating a name data field of a base template with the name data 510 and populating one or more address data fields of the base template with the address data 530, 532. In an aspect, the document header data 520 may be part of the original template or may be altered to include arbitrary data depending on the particular configuration of the system, data privacy regulations or laws applicable to the template, or for other reasons.

The populated template 500 may be provided to a template conversion engine (e.g., the template conversion engine 130 of FIG. 1) configured to generate synthetic data based on the populated template 500. To illustrate, the template conversion engine may be configured to divide the populated template 500 into a grid. It is noted that FIG. 5 illustrates the grid as including vertical lines 502 and horizontal lines 504 for purposes of illustration, rather than by way of limitation and that the populated template need not be divided into an actual grid (e.g., by generating digital lines on the populated template 500 or another technique). The template conversion engine may determine coordinates associated with the different data fields of the populated template 500 based on the grid. For example, the name data may be determined to be bounded within a polygon (e.g., a box) defined by 4 vertices of the grid, shown in FIG. 5 as vertices 512, 514, 516, 518. The vertices of the polygon may then be used to identify a location of the name data 510 on the populated template 500. A similar process may be used to determine coordinates associated with the address data 530, 532 and in some implementations, the document header data 520. It is noted that the populated template 500 of FIG. 5 shows exemplary types of information that may be included in a populated template (e.g., a populated template generated by the template expansion engine of FIG. 1) for purposes of illustration, rather than by way of limitation and that populated templates may include additional types of information that may be identified based on a coordinate system (e.g., the grid) as well as include information in different locations than is shown in the populated template 500 of FIG. 5. Accordingly, it is to be understood that the concepts described above for identifying locations of data within a populated template in accordance with aspects of the present disclosure may be determined in a variety of ways and may include any number of data fields for identification.

Referring back to FIG. 1, once the coordinates and bounding polygons are determined for the data fields of interest (e.g., data fields containing sensitive data, data fields containing non-sensitive data, etc.), the template conversion engine 130 may generate synthetic data for the populated template(s). The synthetic data may be generated in such a way that characteristics of the populated template may be represented in a manner that provides structure to the contents of the populated template. For example, the synthetic data may be generated using JavaScript Object Notation (JSON) or JSON lines (JSONL). It is noted that JSON and JSONL are described herein for purposes of illustration, rather than by way of limitation and that other structured languages and formats may also be used if desired. The synthetic data may contain all of the information and metadata included in the populated template, but may be represented in a file that is of a smaller size and that may be more readily adapted for use in machine learning-based training of a model. For example, the synthetic data may include information that identifies the locations of the data identified within the populated templates, as described above with reference to FIG. 5. The synthetic data may also include the contents of the populated template, such as contents of the identified data fields, special characters (e.g., new line “\n” indicators, etc.), and information that indicates a structure of the populated template (e.g., information that maps the data contents of the populated template with a corresponding polygons where the data contents are located).

An example of synthetic data including location information associated with a populated is shown below:

```
{
    “annotations”: [
      {
      “displayName” : “Loan_ID”,
      “textExtraction” : {
        “textSegment” : {
          “startOffset” : “215”,
          “endOffset” : “225”
        }
  }
    }
    {
      “displayName” : “Closing_agent_state_license_num”,
      “textExtraction” : {
          “textSegment” : {
        “startOffset” : “227”,
          “endOffset” : “258”
        }
  }
    }
    . . .
}
```

As shown above, location information for “Loan ID” information may be associated with a location specified using starting and ending location offsets (e.g., “startOffset”: “215” and “endOffset”: “225”). The starting offset may indicate a position of the text associated with the offsets, such as the corresponding text for the “Loan_ID” starts at the 215^{th} character of the populated template and ends with the 225^{th} character of the populated template. It is noted that the exemplary location information shown above is provided for purposes of illustration, rather than by way of limitation and that synthetic data generated by the template conversion engine 130 of embodiments may include more location information than is shown in the non-limiting example above.

In addition to including the location information, the synthetic data may also include the contents of the populated template, such as contents of the identified data fields, special characters (e.g., new line “\n” indicators, etc.), or other types of information. A non-limiting example of synthetic data generated based on contents of the populated template is shown below:

```
. . .
  “document” : {
    “documentText” : {
      “content” : “Closing disclosure\nThis form is
        provided with your Loan Estimate.\nClosing date
        2/11/2021\nSettlement Agent\n(CO) Bo
        Way\nColorado Springs, CO\n80911\n
        Martell Brianne M.\nMartell\n7119
        . . .
      }
    . . .
  }
. . .
```

As shown above, template contents may include a listing of the alpha-numeric data included in the populated template and may also include additional information, such as new line indicators (e.g., “\n”). It is noted that while the template contents may include information such as names, addresses, or other types of data that could potentially qualify as “sensitive data” subject to data privacy regulations, as described above the template is populated by the template expansion engine 120 with arbitrary data. As such, the names, addresses, and other types of information included in the populated template may not qualify as sensitive data subject to data privacy regulations and rules since it is made up or arbitrary data. It is noted that the exemplary location information shown above is provided for purposes of illustration, rather than by way of limitation and that synthetic data generated by the template conversion engine 130 of embodiments may include more template contents data and different types of template contents data than is shown in the non-limiting example above.

In addition to including the location information and the template contents, the synthetic data may also include information that associates the data with the corresponding polygons identified within the populated document. A non-limiting example of synthetic data including information that associates the data with the corresponding polygons identified within the populated template is shown below:

```
. . .
  “layout” : [
    {
      “textSegment” : {
        “endOffset” : “7”,
        “content” : “Closing”
      }
      “pageNumber” : 1,
      “boundPoly” : {
      “normalizedVertices” : [
        {
          “x” : 0.090016365,
          “y” : 0.05689001
        },
        {
          “x” : 0.18494272,
          “y” : 0.05689001
        },
        {
          “x” : 0.18494272,
          “y” : 0.1468551
        },
      . . .
    }
  . . .
  ]
. . .
```

As shown above, the information that associates the data with the corresponding polygons identified within the populated template may include information associated with contents of the template, such as offset information and content information, page number information (e.g., information that identifies which page of the template the information is associated with), and coordinates of the polygon bounding the information. It is noted that the exemplary synthetic data shown above includes a bounding polygon specified using three different (x, y) coordinate pairs for purpose of illustration, rather than by way of limitation. As such, it should be understood that synthetic data generated by the template conversion engine 130 of embodiments may include more information than is shown in the non-limiting example above. For example, the synthetic data may specify bounding polygons using more than three (x, y) coordinate pairs, may include additional data, different types of data, or other types of information that may be used to capture information related to the relationships between the populated template contents and the bounding polygons identified by the template conversion engine 130.

In a non-limiting example, the template conversion engine 130 may also generate additional instances of synthetic data based on synthetic data derived from a populated template. For example, an instance of the synthetic data generated from one of the populated templates may be further expanded or replicated to produce additional synthetic data. During replication or expansion of the synthetic data, the template conversion engine 130 may replace the arbitrary data derived from the populated template with different arbitrary data, which may include data selected from the one or more databases 118 (e.g., the template expansion database described above with reference to FIG. 4). Stated another way, a populated template may be converted to first synthetic data and then the first synthetic data may be replicated to produce additional synthetic data, where the information included in each instance of the additional synthetic may be different from the first synthetic data. As a result of the synthetic data replication process, the template conversion engine 130 may generate many non-identical instances of the synthetic data. The replication of synthetic data may enable many different instances of a populated template to be generated, thereby providing a robust set of data that may be used to train a model to identify sensitive data within documents and redact sensitive data from those documents prior to providing access to the documents by a user (e.g., a user of the electronic devices 150, 160 or the user device 170).

The template conversion engine 130 may provide the synthetic data (e.g., the synthetic data 206) to the modelling engine 140. As briefly described above, the synthetic data may not include sensitive information and may be created and stored in a structured format (e.g., a JSON or JSONL file, etc.), which may enable the synthetic data to be more readily used to train the model. The synthetic data may be recorded in a smaller file than the populated templates, which may be portable data format (.pdf) files. In addition to a smaller size, the structured nature of the synthetic data may enable the synthetic data to be more easily utilized by the modelling engine 140 to train a model. During training of the model, parameters (e.g., hyperparameters) may be adjusted to improve the accuracy of the model with respect to identifying data values for redaction, such as data values that are subject to data privacy regulations or laws. In an aspect, the data utilized for training the model(s) may be divided into three parts: a training dataset, a testing dataset, and a validation dataset. The validation dataset may be used to tune the hyperparameters for the model and the testing dataset may be leveraged to check the model accuracy on an unseen data set. By utilizing the training, testing, and validation data sets in this manner the robustness of the model and its performance may be evaluated. By training the model using the synthetic data, the model may learn to identify sensitive information within documents and once trained, the model may be utilized to analyze and evaluate documents (e.g., the document(s) 210 of FIG. 2) containing sensitive information and redact the identified sensitive information to produce redacted documents (e.g., the redacted document(s) 212 of FIG. 2). The redacted documents may then be shared with or accessed by various individuals without running the risk of violating data privacy regulations or laws.

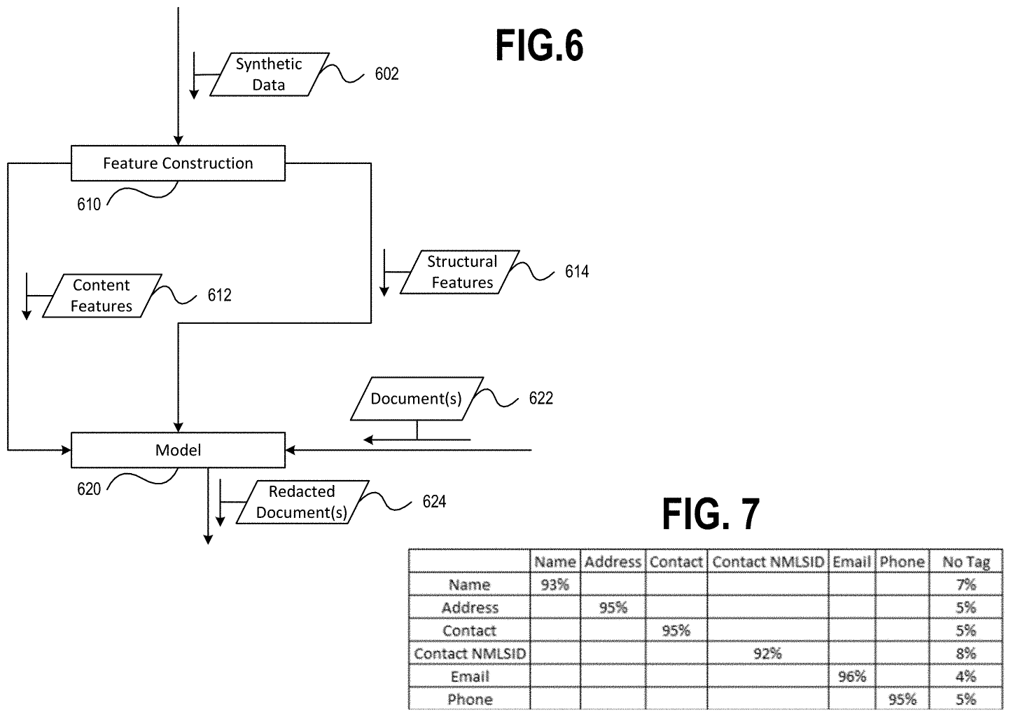

To illustrate and referring to FIG. 6, a block diagram illustrating a process for training a model using synthetic data in accordance with aspects of the present disclosure is shown. It is noted that the operations described with reference to FIG. 6 may be performed by a modelling engine, such as the modelling engine 140 of FIGS. 1 and 2. As shown in FIG. 6, the modelling engine may receive synthetic data 602 (e.g., the synthetic data 206 of FIG. 2). The synthetic data 602 may include information derived from a plurality of different populated templates and in some aspects, may include synthetic data generated via a synthetic data replication process. For example, as described above with respect to the template conversion engine 130 of FIG. 1 and FIG. 5, the template conversion process may be utilized to analyze multiple populated templates and produce synthetic data representative of each of the populated templates.

The synthetic data 602 may be provided as an input to a feature construction module 610 of the modelling engine. The feature construction module 610 may be configured to extract content features 612 and structural features 614 from the synthetic data 602. The content features 612 may identify features associated with the content of the synthetic data 602 (and the populated templates used to generate the synthetic data). For example, the synthetic data 602 may include content associated with a phone number. The phone number content may be analyzed by the feature construction module 610 to identify features that may be used to detect or identify a phone number within the synthetic data (and a document). For example, the phone number features may indicate that a series of 7 numbers (e.g., a phone number without an area code) or 10 numbers (e.g., a phone number with an area code) is a phone number. The phone number features may also indicate that a sequence of three numbers in parentheses (e.g., “(###)”) followed by 7 numbers (e.g., “(###) 1234567”) or a sequence of 3 numbers followed by a dash (“—”) followed by 4 more numbers (e.g., “(###) 123-4567”) is a phone number. Similarly, content features may indicate that one or more numbers followed by a sequence of letters may be a street address (e.g., #### ABCDEFG) and that certain abbreviations (e.g., Dr., Ave., Rd., St., and the like) may be street addresses. Additional content features may indicate that a sequence of letters followed by a comma (“,”) and then two letters and a series of numbers may indicate city, state, zip code address information (e.g., ABCD, TX #####). It is noted that the content features 612 described above are provided for purposes of illustration, rather than by way of limitation and that the feature construction module 610 of embodiments may be configured to identify additional content features or utilize other types of content features to identify the various non-limiting examples described above.

The structural features 614 may include features associated with a location of information, relationships between different data fields, or other types of template structural information that may be derived from the synthetic data 602. For example, in the exemplary populated template 500 of FIG. 5 the address data fields 530, 532 are positioned below the name data field 510. The structural features 614 may also indicate that the document header data 520 is located in the top left region of the populated template 500 of FIG. 5. Identifying the different structural features 614 based on the synthetic data 602 may improve the accuracy of the model during training, such as by providing information about the expected locations of data within a particular template or document.

The content features 612 and the structural features 614 may be utilized as inputs during a process to train a model 620. The training process may utilize machine learning to teach the model 620 to identify sensitive data and content within documents containing sensitive data (i.e., data that is subject to data privacy regulations and laws), such as the document(s) 210 of FIG. 2. Once trained based on the content features 612 and the structural features 614 derived from the synthetic data 602, the model 620 may be used to redact information from documents containing sensitive data. For example, suppose that a user (e.g., a user of the electronic device 150, 160 or the user device 170) requests access to a document 622 but that data privacy regulations require that the user's access be restricted by redacting certain sensitive information from the document 622. Traditionally, redaction of the document 622 may be performed manually and may be a time consuming process. However, in accordance with aspects of the present disclosure, the document 622 may be evaluated against the model 620 to identify sensitive data that should be redacted and may redact the identified data to produce a redacted document 624. The redacted document 624 may then be provided to the user in compliance with the relevant data privacy requirements and laws. Notably, using the model 620 to perform document redaction may significantly increase the speed at which the redaction process takes place while maintaining a high level of accuracy with respect to correctly redacting sensitive data. Such capabilities may enable documents and information to be shared more quickly and remove bottlenecks associated with previously used techniques.

To illustrate and referring to FIG. 7, a confusion matrix demonstrating the accuracy of a model-based approach to document redaction in accordance with aspects of the present disclosure is shown. The confusion matrix of FIG. 7 indicates a plurality of types of sensitive data that were tested using the various processes described above with reference to FIGS. 1-6, such as template acquisition and expansion, synthetic data generation (and expansion), feature extraction (e.g., the content features 612 and the structural features 614), training of a model, and the like. Once the model was trained, documents containing sensitive data (e.g., loan applications, etc.) were then evaluated against the model and sensitive information was redacted. During the redaction process, information associated with names, addresses, contact information (e.g., a loan officer's name), contact NMLSID information (e.g., the National Mortgage Loan Service Identifier of the contact), e-mail addresses, and telephone numbers were identified as sensitive data for redaction. The model was able to identify these different pieces of information with an overall accuracy of 95%. It is noted that one of the benefits of utilizing the machine learning-based techniques to train the model is that the accuracy of the model may improve over time as more data is accumulated for training purposes. It is noted that the high levels of accuracy achieved by the models may be the result of utilizing the expansion processes described herein, which produce non-identical content within the same overall document template (or synthetic data). This produces data having a high structural consistency despite the contents of the various data fields being populated with different arbitrary data and enables training of the model to be thoroughly performed.

Referring back to FIG. 1, the redaction device 110 may utilize the techniques described above with reference to FIG. 6 to train a model provided by the modelling engine 140. The training may be based on a robust data set of training information generated based on synthetic data, which may include synthetic data generated from one or more populated templates and the above-described synthetic data expansion techniques. Once the model is trained, the redaction device may be configured to receive requests for documents, such as a request from one of the electronic device 150, 160 or the user device 170. Upon receiving the request, the redaction device 110 may evaluate the document against the trained model to identify data fields having data values that should be redacted in accordance with applicable privacy requirements or laws. The redaction of the document may produce a redacted document that may then be transmitted to the requestor device.

The automated techniques for redaction of documents provided by the redaction device 110 enable sensitive data to be redacted in manner that is consistent with applicable data privacy regulations and requirements and may also enable data redaction to be performed more quickly than existing approaches while maintaining a high degree of accuracy, as described above with reference to FIG. 7. Due the increased speed by which data redaction may be performed, the redaction device 110 may also facilitate more rapid sharing of documents without increasing the chances that data is inaccurately redacted. Furthermore, the automated redaction processes of embodiments may also allow document redaction to be integrated with different systems and services. For example, rather than implementing the redaction device 110 as a standalone device, as shown in FIG. 1, the functionality of the redaction device 110 may be provided as a cloud-based service accessible to third party systems, such as the electronic devices 150, 160 or the user device 170. Additionally, the functionality provided by the redaction device 110 may be embodied in software that may be installed on third party systems, such as the electronic devices 150, 160 or the user device 170. Such an embodiment may provide an additional layer of data privacy and protection since the documents may be retained by an entity that already has the documents, rather than having to provide the document(s) to a third party via transmission over one or more networks.

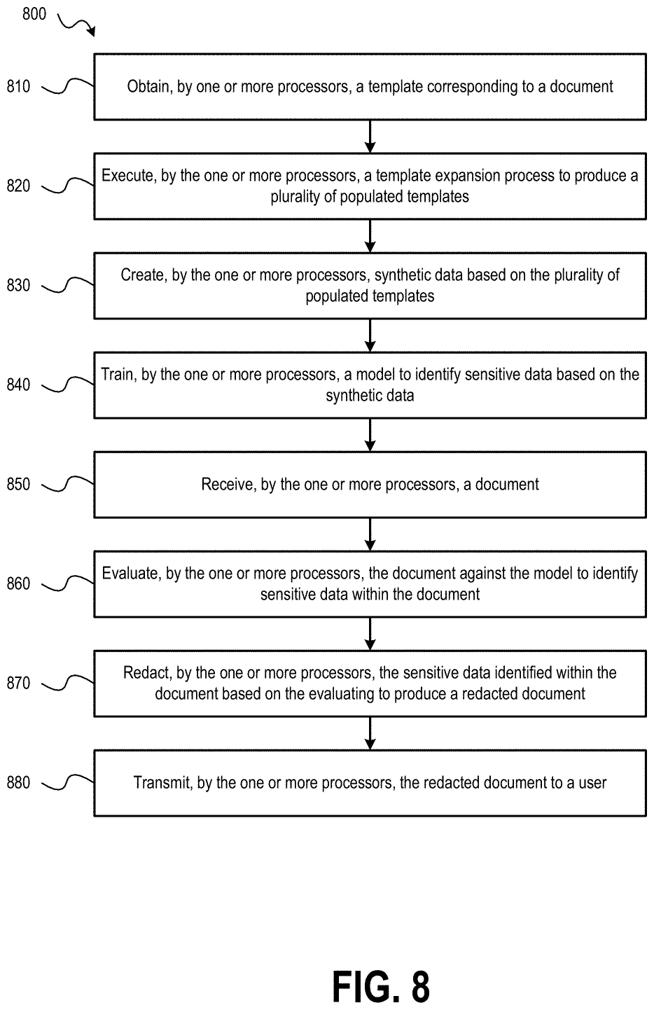

Referring to FIG. 8, a flow diagram of an example of a method for redacting data according to one or more aspects of the present disclosure is shown as a method 800. In some implementations, the operations of the method 800 may be stored as instructions (e.g., the instructions 116 of FIG. 1) that, when executed by one or more processors (e.g., the one or more processors 112 of FIG. 1), cause the one or more processors to perform the operations of the method 800. In some implementations, the method 800 may be performed by a computing device, such as the redaction device 110 of FIG. 1.

At step 810, the method 800 includes obtaining, by one or more processors, a template corresponding to a document. In an aspect, the templates may be blank templates. At step 820, the method 800 includes executing, by the one or more processors, a template expansion process to produce a plurality of populated templates. In an aspect, the template expansion process may be performed by a template expansion engine, such as the template expansion engine 120 of FIGS. 1 and 2). As described above, each populated template of the plurality of populated templates may include data that is not subject to data privacy requirements, such as data selected from a template expansion database. In some aspects, the populated templates may be generated by manually populating the templates obtained at step 810.

At step 830, the method 800 includes creating, by the one or more processors, synthetic data based on the plurality of populated templates. In an aspect, the synthetic data may be generated by a template conversion engine, such as the template conversion engine 130 of FIGS. 1 and 2. As described above, the synthetic data my include information associated with the contents of the populated template, location information, and structural information. The synthetic data may be generated using a structured format, as described above, which may enable the synthetic data to be more readily ingested by the model and which may reduce a size of the data as compared to the populated templates. In some aspects, the process to generate the synthetic data may also include a synthetic data expansion process, whereby an instance of the synthetic data derived from one populated template is then used to generate multiple additional instance of the synthetic data that include different information (i.e., different data field values).

At step 840, the method 800 includes training, by the one or more processors, a model to identify sensitive data based on the synthetic data. In an aspect, the training may be performed by a modelling engine, such as the modelling engine 140 of FIGS. 1, 2, and 6. As described above, the training of the model may include deriving content features (e.g., the content features 612 of FIG. 6) and structural features (e.g., the structural features 614 of FIG. 6). The training of the model may utilize machine learning techniques to teach the model to identify sensitive data within different types of documents, which may then enable the model to be used to redact information. For example, at step 850, the method 800 includes receiving, by the one or more processors, a document. In an aspect, the document may be the document 210 of FIG. 2 or the documents 622 of FIG. 6.

At step 860, the method 800 includes evaluating, by the one or more processors, the document against the model to identify sensitive data within the document and at step 870, redacting, by the one or more processors, the sensitive data identified within the document based on the evaluating to produce a redacted document. As described above, redacting the sensitive data my include covering the sensitive data (e.g., with a black box), obfuscating the sensitive data, or other techniques to prevent the sensitive data from being viewed or accessed. At step 880, the method 800 includes transmitting, by the one or more processors, the redacted document to a user.

As described above, the method 800 supports automated redaction of documents in a manner that is consistent with applicable data privacy regulations and requirements. The data redaction techniques of the method 800 may enable data redaction to be performed more quickly than existing approaches and with a high degree of accuracy, thereby enabling documents to be shared more quickly. Additionally, the ability to automate the redaction process may also allow document redaction to be integrated within different systems and services, which may minimize the chances that documents are shared or accessed without data redaction being performed. It is noted that additional advantages and benefits provided by the method 800 and the concepts disclosed herein may be readily recognized and appreciated by persons of skill in the art and that the explicit benefits described herein are intended to merely highlight some of the advantages provided by the present disclosure.

It is noted that other types of devices and functionality may be provided according to aspects of the present disclosure and discussion of specific devices and functionality herein have been provided for purposes of illustration, rather than by way of limitation. It is noted that the operations of the method 800 of FIG. 8 may be performed in any order, or that operations of one method may be performed during performance of another method. It is also noted that the method 800 of FIG. 8 may also include other functionality or operations consistent with the description of the operations of the system 100 of FIG. 1 and the exemplary operations, functionality, and features described with reference to FIGS. 2-7.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-6 and 8) include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A method for redacting data from a document, the method comprising:
obtaining, by one or more processors, a template corresponding to a document;
executing, by the one or more processors, a template expansion process configured to generate a populated template comprising data that is not subject to data privacy requirements;
creating, by the one or more processors, synthetic data based on the populated template;
training, by the one or more processors, a model to identify sensitive data within the document corresponding to the template based on the synthetic data;
receiving, by the one or more processors, a request to access an instance of the document corresponding to the template, wherein the instance of the document comprises data that is not subject to data privacy requirements;
evaluating, by the one or more processors, the instance of the document against the model to identify sensitive data within the instance of the document;
redacting, by the one or more processors, the sensitive data identified within the instance of the document based on the evaluating to produce a redacted document; and
transmitting, by the one or more processors, the redacted document to a user.

2. The method of claim 1, further comprising:
generating, during the template expansion process, a plurality of additional populated templates comprising additional data that is not subject to data privacy requirements, wherein the data and the additional data are different, and wherein the data and the additional arbitrary data are selected from a template expansion database.

3. The method of claim 1, wherein the data that is not subject to data privacy requirements comprises one or more types of information selected from the list consisting of: names, addresses, telephone numbers, financial account information, financial card information, license or certification information, identification card information, or service account information.

4. The method of claim 1, wherein creation of the synthetic data comprises:
determining structural information associated with different portions of the data of the populated template; and
converting the data of the populated template to a machine-readable format.

5. The method of claim 4, wherein the machine-readable format comprises a structured language format, and wherein the synthetic data comprises location information associated with the data of the populated template, a copy of the data included in the populated template, and the structural information associated with different portions of the data of the populated template.

6. The method of claim 5, wherein the location information identifies at least one offset corresponding to each term or phrase within the data of the populated template.

7. The method of claim 5, wherein the copy of the data included in the populated template comprises each of term and phrase within the populated template.

8. The method of claim 5, wherein the structural information identifies one or more polygons within the populated template, wherein each of the one or more polygons corresponds to a region of the populated template that bounds a term or a phrase within the populated template.

9. The method of claim 8, wherein determining the structural information comprises:
creating a coordinate system based on the populated system; and
determining vertices associated with each of the one or more polygons within the coordinate system.

10. The method of claim 5, wherein the structured language format comprises a JavaScript Object Notation (JSON) format or a JSON Lines (JSONL) format.

11. A system for redacting data from a document, the system comprising:
a memory configured to store data that is not subject to data privacy requirements; and
one or more processors communicatively coupled to the memory, the one or more processors configured to:
obtain a template corresponding to a document;
execute a template expansion process configured to generate a plurality of populated templates, each populated template comprising data that is not subject to data privacy requirements;
create synthetic data based on the plurality of populated templates;
train a model to identify sensitive data within the documents corresponding to each of the plurality of templates based on the synthetic data;
receive a request to access an instance of a document corresponding to a template of the plurality of templates, wherein the instance of the document comprises data that is subject to data privacy requirements;
evaluate the instance of the document against the model to identify sensitive data within the instance of the document;
redact the sensitive data identified within the instance of the document based on the evaluating to produce a redacted document; and
transmit the redacted document to a user.

12. The system of claim 11, wherein the data that is not subject to data privacy requirements comprises one or more types of information selected from the list consisting of: names, addresses, telephone numbers, financial account information, financial card information, license or certification information, identification card information, or service account information.

13. The system of claim 11, wherein creation of the synthetic data comprises:
determining structural information associated with different portions of the data of the populated template; and
converting the data of the populated template to a machine-readable format, wherein the machine-readable format comprises a structured language format, and wherein the synthetic data comprises location information associated with the data of the populated template, a copy of the data included in the populated template, and the structural information associated with different portions of the data of the populated template.

14. The system of of claim 13, wherein the location information identifies a start offset and an end offset corresponding to each term or phrase within the data of the populated template, wherein the copy of the data included in the populated template comprises each of the terms and phrases within the populated template, wherein the one or more processors are configured to:
create a coordinate system based on the populated template;
determine one or more polygons within the populated template, each of the one or more polygons corresponding to a region of the populated template that bounds one of the terms or the phrases within the populated template; and
determining vertices associated with each of the one or more polygons within the coordinate system, wherein the structural information associated with the different portions of the data of the populated template comprises information associated with the vertices of the one or more polygons.

15. The system of claim 11, wherein creation of the synthetic data based on the plurality of populated templates comprises:
generating a first the synthetic data based on a first populated template; and
replicating the first synthetic data to produce at least one additional instance of the first synthetic data; and
replacing data included in the at least one additional instance of the first synthetic data with different data that is not subject to data privacy requirements such that the first synthetic data and each of the at least one additional instances of the first synthetic data comprise different data.

16. A non-transitory computer-readable storage medium storing instructions that, when executed by one or more processors, cause the one or more processors to perform operations for redacting data from a document, the operations comprising:
execute a template expansion process configured to generate a plurality of populated templates, each populated template corresponding to an instance of a blank template and comprising data fields populated with data values;
creating synthetic data based on the plurality of populated templates;
training a model to identify data values or data fields comprising information for redaction based on the synthetic data;
receiving a request to access an instance of a document corresponding to the blank template, wherein the instance of the document comprises data fields populated with particular data values;
evaluating the instance of the document against the model to identify data values or data fields comprising information for redaction;
redacting the data fields or the data values identified within the instance of the document based on the evaluating to produce a redacted document; and
transmitting the redacted document to a user.

17. The non-transitory computer-readable storage medium of claim 16, the operations comprising:
creating a coordinate system based on the populated template;
determining one or more polygons within the populated template, each of the one or more polygons corresponding to a region of the populated template that bounds a term or a phrase within the populated template; and
determining vertices associated with each of the one or more polygons based on the coordinate system, wherein the synthetic data comprises information associated with the vertices of each of the one or more polygons.

18. The non-transitory computer readable storage medium of claim 16, wherein training the model comprises:
generating a content features and structural features based on the synthetic data; and
configuring parameters of the model based on the content features and the structural features, the parameters configured to identify the data values or the data fields comprising information for redaction.

19. The non-transitory computer-readable storage medium of claim 18, wherein the content features comprise characteristics representative of data values comprising information for redaction.

20. The non-transitory computer-readable storage medium of claim 18, wherein the structural features comprise characteristics representative of data fields comprising information for redaction.
